(19) United States
(12) Patent Application Publication
(10) Pub. No.: US 2017/0162143 A1
(43) Pub. Date: Jun. 8, 2017

(54) LIQUID CRYSTAL DISPLAY PANEL AND DRIVING METHOD THEREOF

(71) Applicant: SHENZHEN CHINA STR OPTOELECTRONICS TECHNOLOGY CO. LTD., GUANGDONG (CN)

(72) Inventor: Sikun HAO, Guangdong (CN)

(21) Appl. No.: 14/905,969

(22) PCT Filed: Dec. 30, 2015
(86) PCT No.: PCT/CN2015/099655

§ 371 Date: Jan. 19, 2016

(30) Foreign Application Priority Data
Dec. 3, 2015 (CN) 201510882132.6

(51) Int. Cl. G09G 3/36; G02F 1/137; G02F 1/1362; G02F 1/1337; G02F 1/1368

(52) U.S. Cl. CPC G09G 3/3648; G02F 1/1337; G02F 1/1368; G02F 1/136286; G02F 1/137; G09G 2300/0426; G09G 2300/0465; G09G 2320/0242; G09G 2320/066; G09G 2340/10; G02F 2001/133742

(57) ABSTRACT

A liquid crystal display panel and a driving method thereof are provided. The driving method has steps of displaying one screen by two frame figures which are driven by two different driving voltages, such that liquid crystal molecules corresponding to pixel units have two orientations; and superimposing a brightness and a chrominance of the frame figures to form a display figure of the screen. Because one screen is displayed by two frame figures driven by different driving voltages and superimposed, the liquid crystal molecules corresponding to the pixel units have two orientations, so as to improve the declining contrast of a wide viewing angle and a color shift of a vertical alignment liquid crystal display. Thus, the viewing angle can be wider. Only one TFT switch is needed for the panel, and an aperture ratio and a penetration rate of the pixel are improved at least 20%.

### FIELD OF THE INVENTION

The present invention relates to a technical field of liquid crystal displays, and in particular to a driving method of a liquid crystal display panel, and a liquid crystal display panel driven by the driving method.

### BACKGROUND OF THE INVENTION

Liquid crystal displays (LCD), with the advantages of being light and thin, has become one of the fastest growing display panels. Compared with a cathode ray tube display, thin film transistor (TFT-LCD) has a narrow viewing angle, and a high technical field of displays would be limited, such as aerospace and medical. With the rapid development of wide viewing angle of the LCD technical field, the viewing angles of many products can reach a horizontal viewing angle of 85° and a vertical viewing angle of 85° or more.

Vertical alignment liquid crystal displays (VA-LCD) have the advantages of a wide viewing angle, a high contrast, and an alignment without friction, and have become a common display in large sized TFT-LCD, and they have the disadvantages of a declining contrast from a wide viewing angle and a color shift.

To solve the foregoing problems, related manufacturers further developed a plurality of the pixel structures to reduce the color shift, such as space low, which is dividing the ITO area of the pixel unit to from several domains, the domains with different brightness are disposed by TFT to reach the low color shift effect from a wide viewing angle.

Refer to FIG. 1, which is an equivalent circuit of a traditional vertical alignment liquid crystal display with a pixel unit of three thin film transistors. A liquid crystal capacitor Clc-A, a storage capacitor Cst-A, and charge-sharing capacitors Ccs-A, Ccs-B are discharged by TFT1 in pixel electrode A, and a liquid crystal capacitor Clc-B, and a storage capacitor Cst-B are discharged by TFT2 in pixel electrode B when Gn outputs a high level voltage, which can achieve pixel voltage VpA and pixel voltage VpB being the same, generally. TFT1 and TFT2 are turned off, Gn+1 outputs a high level voltage, TFT3 is turned on after discharging, and Node C reaches a voltage which is the pixel voltage VpB in pixel electrode B by dividing the voltage from the charge-sharing capacitors Ccs-A, Ccs-B. There is a voltage between the pixel voltage VpA and the pixel voltage VpB, such that the domains have different brightnesses to reach the low color shift effect from a wide viewing angle.

However, there is a low aperture ratio existing in the pixel, such that a penetration rate of a cell (an LCD screen coupled with PCB and COF), and the cost of the backlight would be increased.

The inventor has therefore tried to solve the existing problems and the disadvantage of the traditional vertical alignment liquid crystal display and declining contrast from a wide viewing angle, and a problem of a color shift.

### SUMMARY OF THE INVENTION

An object of the present invention is to provide a driving method of a liquid crystal display panel and a liquid crystal display panel, which improve a vertical alignment liquid crystal display with a problem of declining contrast from a wide viewing angle and a problem of a color shift, such that viewing angle can be wider.

To achieve the above object, the present invention provides a driving method of a liquid crystal display panel which comprises steps of: displaying one screen by two frame figures, wherein the two frame figures are driven by two different driving voltages respectively, such that liquid crystal molecules corresponding to pixel units have two orientations; and superimposing a brightness and a chrominance of the two frame figures with each other to form a display figure of the screen.

In one embodiment of the present invention, each of the two driving voltages driving the two frame figures has a polarity and a voltage value, the polarity of the two driving voltages are identical, and the voltage value of the two driving voltages are different.

In one embodiment of the present invention, each of the two driving voltages driving the two frame figures has a polarity and a voltage value, the polarities of the two driving voltages are different, and the voltage values of the two driving voltages are different.

To achieve the above object, the present invention further provides a liquid crystal display panel which includes a data line for transmitting data signals, a scan line for transmitting scan signals, a switch connected between the data line and a pixel electrode and turned on by receiving the scan signals of the scan line, a storage capacitor connected between the pixel electrode and a common electrode, and a liquid crystal capacitor including an end connected to the pixel electrode. The data signals of the data line is transmitted to the storage capacitor through the switch when the switch is turned on by receiving a turn-on signal of the scan line, such that the storage capacitor is charged to reach a corresponding electric potential based on the data signals, and the pixel electrode has the corresponding electric potential.

In one embodiment of the present invention, the switch includes a source connected to the data line, a drain connected to the pixel electrode, and a gate connected to the scan line.

In one embodiment of the present invention, the other end of the liquid crystal capacitor is connected to the common electrode.

In one embodiment of the present invention, the liquid crystal display panel further comprises a figure display area, the figure display area includes a pixel area formed by alternately arranging a plurality of the data lines and a plurality of the scan lines, and each of the pixel units is disposed in the pixel area.

In one embodiment of the present invention, the liquid crystal display panel further comprises a source driver and a gate driver, the source driver is coupled with the data lines for providing the data signals to the figure display area, and the gate driver is coupled with the scan lines for providing the scan signals to the figure display area.

The advantage of the present invention is that by displaying one screen by two frame figures which are driven by two different driving voltages respectively and superimposed with each other, such that liquid crystal molecules corresponding to pixel units have two orientations at different time. For a vertical alignment liquid crystal display, a problem of declining contrast from a wide viewing angle and a problem of a color shift can be improved, such that viewing angle can be seen from a wider angle. Furthermore, the liquid crystal display panel of the present invention only needs a thin film transistor (TFT) switch, and an aperture ratio and a penetration rate of the pixel is improved at least 20%.

### DESCRIPTION OF THE DRAWINGS

In order to more clearly illustrate the embodiments or the prior art technical solutions embodiment of the present invention, will implement the following figures for the cases described in the prior art or require the use of a simple introduction. Obviously, the following description of the drawings are only some of those of ordinary skill in terms of creative effort without precondition, you can also obtain other drawings based on these drawings embodiments of the present invention.

FIG. 1 is an equivalent circuit of a traditional vertical alignment liquid crystal display with a pixel unit of three thin film transistors.

FIG. 2 is a schematic view of a driving method of a traditional vertical alignment liquid crystal display.

FIG. 3 is a schematic view of an orientation of a traditional vertical alignment liquid crystal display.

FIG. 4 is a schematic view of an orientation of a driving method of a vertical alignment liquid crystal display of the present invention.

FIG. 5 is an average time effect of an orientation of a driving method of a vertical alignment liquid crystal display of the present invention.

FIG. 6 is a schematic view of an embodiment of a driving method of the present invention.

FIG. 7 is a schematic view of another embodiment of a driving method of the present invention.

FIG. 8 is a schematic view of another embodiment of a vertical alignment liquid crystal display of the present invention.

FIG. 9 is a schematic view of pixels of the present invention.

FIG. 10 is an equivalent circuit of pixel units.

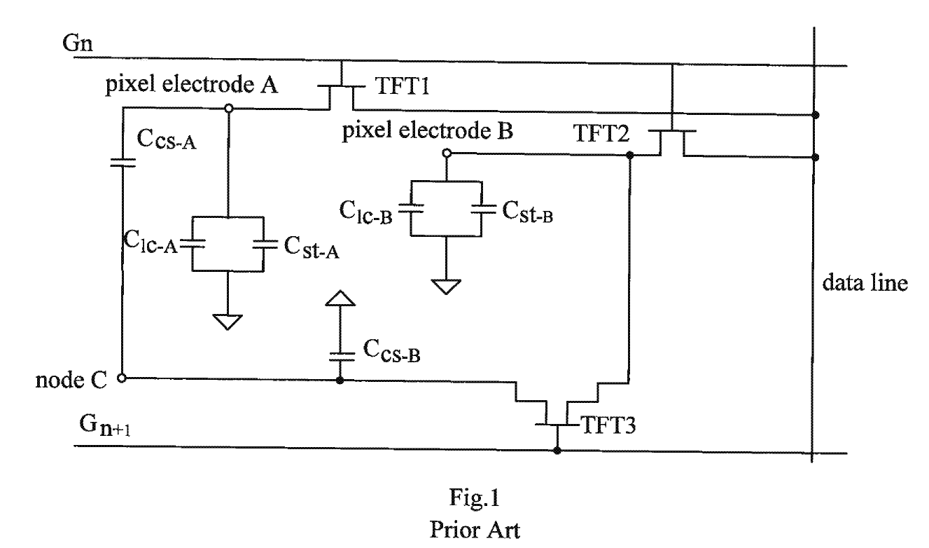

### DETAILED DESCRIPTION OF THE PREFERRED EMBODIMENTS

The following description of the embodiments with reference to the attached drawings illustrates how the present invention may be used to implement a particular embodiment.

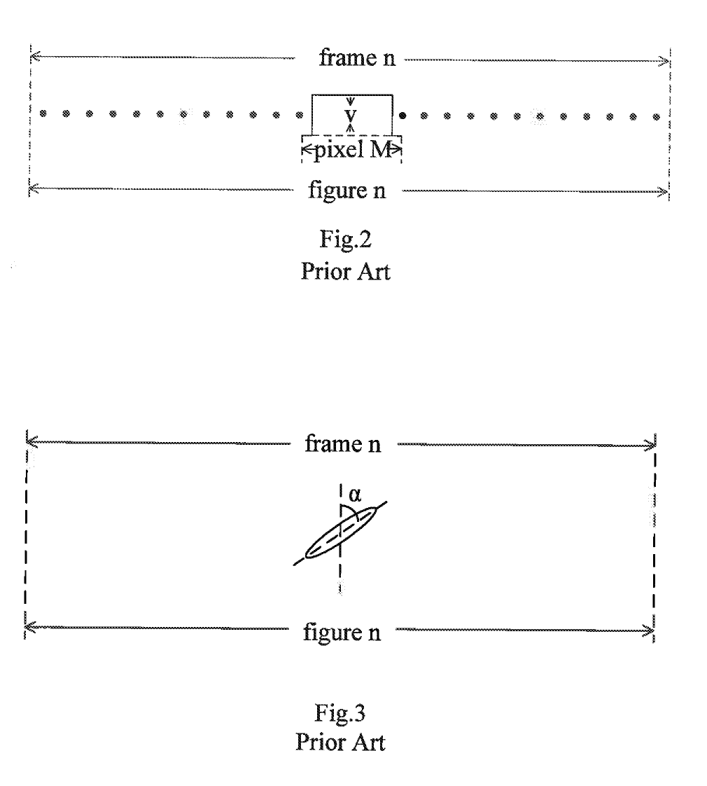

Refer to FIG. 2, a screen of a traditional vertical alignment liquid crystal display is driven by one voltage, and a figure is displayed by a frame. In FIG. 2, “figure n” means the n^{th} figure, and “frame n” means the n^{th} frame. Each of the frames has some pixels, one of the pixels is indicated by “pixel M”. The traditional vertical alignment liquid crystal display is driven by one voltage, such that liquid crystal molecules of a pixel have only one orientation. Refer to FIG. 3, the orientation angle α of all of the liquid crystal molecules is the same.

The present invention provides a driving method of a liquid crystal display panel which comprises steps of:

(1) displaying one screen by two frame figures, wherein the two frame figures are driven by two different driving voltages respectively, such that liquid crystal molecules corresponding to pixel units have two orientations.

(2) superimposing a brightness and a chrominance of the two frame figures with each other to form a display figure of the screen.

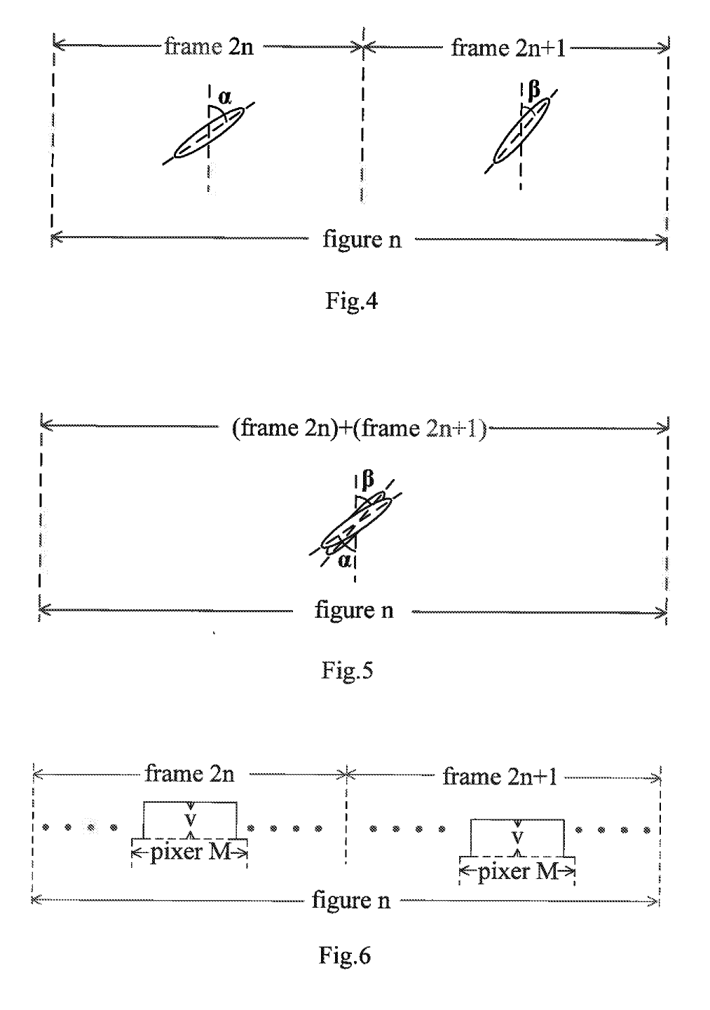

One screen is driven by two different driving voltages respectively, such that liquid crystal molecules of each of pixels include an orientation angle α and orientation angle β at different times. Refer to FIG. 4, frame 2n and frame 2n+1 are adopted to display figure n. Refer to FIG. 5, frame 2n and frame 2n+1 are superimposed for displaying figure n. According to an average time effect, liquid crystal molecules of each of pixels in one screen have two orientations at different time, such that the viewing angle can be seen from a wider angle.

Wherein frame 2n and frame 2n+1 are driven by two different driving voltages respectively, and two methods can be adopted, as follows:

Refer to FIG. 6, one method is that frame 2n and frame 2n+1 are driven by two driving voltages, and each of the two driving voltages has a polarity and a voltage value, the polarity of the two driving voltages are identical, and the voltage value of the two driving voltages are different, such as frame 2n is driven by a large driving voltage, and frame 2n+1 is driven by a small driving voltage.

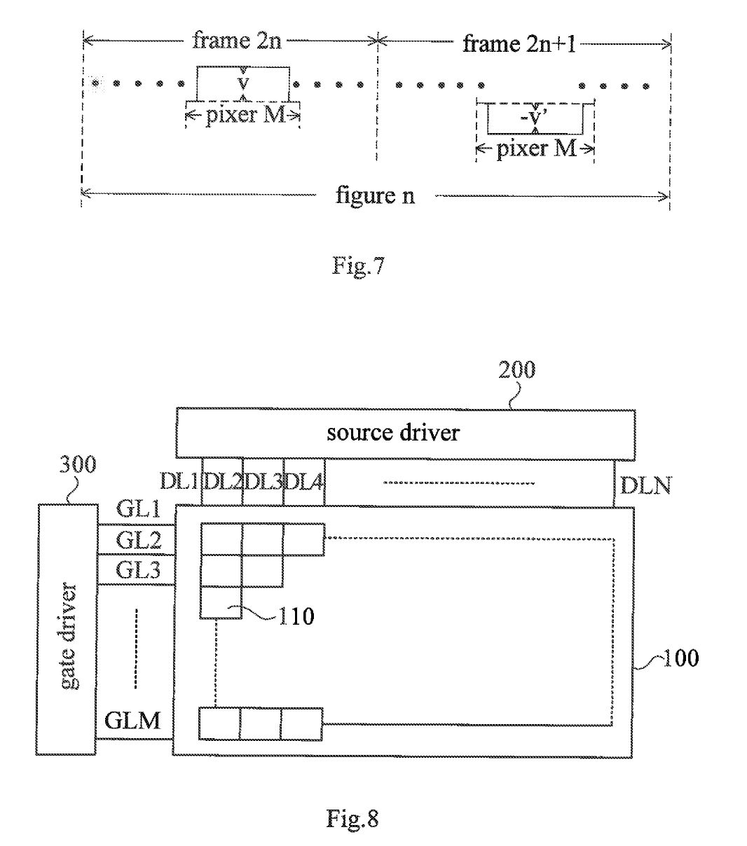

Refer to FIG. 7, the other method is that frame 2n and frame 2n+1 are driven by two driving voltages, and each of the two driving voltages has a polarity and a voltage value, the polarity of the two driving voltages are different, and the voltage value of the two driving voltages are different, such as frame 2n is driven by a positive and large driving voltage, and frame 2n+1 is driven by a negative and small driving voltage.

The present invention further provides a liquid crystal display panel adopting the driving method. Refer to FIG. 8, the liquid crystal display panel includes a figure display area 100, a source driver 200 and a gate driver 300.

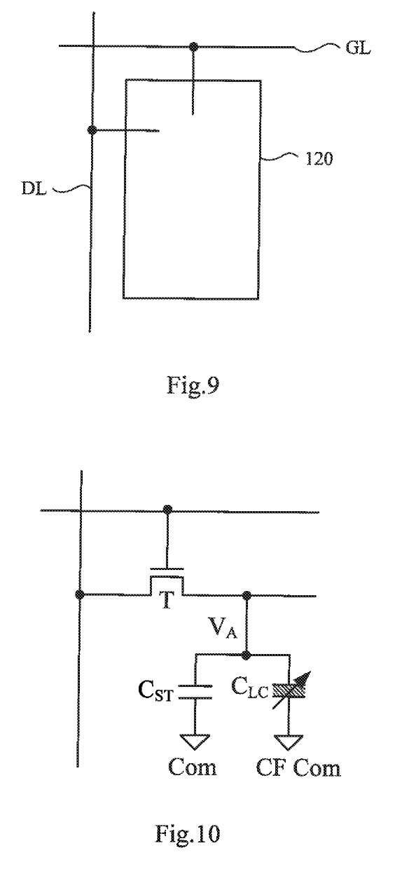

The figure display area 100 includes a plurality of the data lines DL (N^{st} data lines DL 1 to DL N, shown in FIG. 8), and a plurality of the scan lines GL (M^{st} scan lines GL 1 to GL M, shown in FIG. 8), a pixel area 110 is formed by alternately arranging the data lines DL and the scan lines GL in FIG. 9, and each of the pixel units 120 is disposed in the pixel area 110.

The source driver 200 is coupled with the data lines DL for providing the data signals to the figure display area 100. The gate driver 300 is coupled with the scan lines GL for providing the scan signals to the figure display area 100.

Refer to FIG. 10, which is an equivalent circuit of pixel units 120, and each of the pixel units 120 has a data line DL, a scan line GL, a switch T, a storage capacitor Cst, and a liquid crystal capacitor Clc, wherein the switch T can be a thin film transistor.

The source driver 200 is coupled with the data lines DL for providing the data signals to the figure display area 100. The gate driver 300 is coupled with the scan lines GL for providing the scan signals to the figure display area 100.

The switch T is connected between the data line DL and a pixel electrode VA, and the switch T is turned on by receiving the scan signals of the scan line GL. Specifically, the switch T includes a source (not shown), a drain (not shown), and a gate (not shown), the data line DL is connected to the source, the scan line GL is connected to the gate, and the pixel electrode VA is connected to the gate.

The storage capacitor Cst is connected between the pixel electrode VA and a common electrode Com, an end of the liquid crystal capacitor is connected to the pixel electrode VA, and the other end of the liquid crystal capacitor is connected to a common electrode CF Com.

The data signals of the data line DL is transmitted to the storage capacitor Cst through the switch T when the switch T is turned on by receiving a turn-on signal of the scan line GL, such that the storage capacitor Cst is charged to reach a corresponding electric potential based on the data signals, and the pixel electrode VA has the corresponding electric potential, such that the pixel units 120 can display figures.

The liquid crystal display panel of the present invention only needs the switch T, and an aperture ratio and a penetration rate of the pixel are improved at least 20%.

The present invention has been described with preferred embodiments thereof and it is understood that many changes and modifications to the described embodiments can be carried out without departing from the scope and the spirit of the invention that is intended to be limited only by the appended claims.

What is claimed is:

1. A driving method of a liquid crystal display panel, comprising steps of: displaying one screen by two frame figures, wherein the two frame figures are driven by two different driving voltages respectively, such that liquid crystal molecules corresponding to pixel units have two orientations; and superimposing a brightness and a chrominance of the two frame figures with each other to form a display figure of the screen.

2. The driving method of the liquid crystal display panel according to claim 1, wherein each of the two driving voltages driving the two frame figures has a polarity and a voltage value, the polarity of the two driving voltages are identical, and the voltage value of the two driving voltages are different.

3. The driving method of the liquid crystal display panel according to claim 1, wherein each of the two driving voltages driving the two frame figures has a polarity and a voltage value, the polarities of the two driving voltages are different, and the voltage values of the two driving voltages are different.

4. A liquid crystal display panel, including a plurality of pixel units, and each of the pixel units comprising:
a data line for transmitting data signals;
a scan line for transmitting scan signals;
a switch connected between the data line and a pixel electrode, and turned on by receiving the scan signals of the scan line, wherein the switch includes a source connected to the data line, a drain connected to the pixel electrode, and a gate connected to the scan line;
a storage capacitor connected between the pixel electrode and a common electrode; and
a liquid crystal capacitor including an end connected to the pixel electrode, and the other end connected to the common electrode;
wherein the data signals of the data line are transmitted to the storage capacitor through the switch when the switch is turned on by receiving a turn-on signals of the scan line, such that the storage capacitor is charged to reach a corresponding electric potential based on the data signals, and the pixel electrode has the corresponding electric potential.

5. The liquid crystal display panel according to claim 4, wherein the liquid crystal display panel further comprises a figure display area, the figure display area includes a pixel area formed by alternately arranging a plurality of the data lines and a plurality of the scan lines, and each of the pixel units is disposed in the pixel area.

6. The liquid crystal display panel according to claim 5, wherein the liquid crystal display panel further comprises a source driver and a gate driver, the source driver is coupled with the data lines for providing the data signals to the figure display area, and the gate driver is coupled with the scan lines for providing the scan signals to the figure display area.

7. A liquid crystal display panel, including a plurality of pixel units, and each of the pixel units comprising:
a data line for transmitting data signals;
a scan line for transmitting scan signals;
a switch connected between the data line and a pixel electrode, and turned on by receiving the scan signals of the scan line;
a storage capacitor connected between the pixel electrode and a common electrode; and
a liquid crystal capacitor including an end connected to the pixel electrode;
wherein the data signals of the data line is transmitted to the storage capacitor through the switch when the switch is turned on by receiving a turn-on signal of the scan line, such that the storage capacitor is charged to reach a corresponding electric potential based on the data signals, and the pixel electrode has the corresponding electric potential.

8. The liquid crystal display panel according to claim 7, wherein the switch includes a source connected to the data line, a drain connected to the pixel electrode, and a gate connected to the scan line.

9. The liquid crystal display panel according to claim 7, wherein the other end of the liquid crystal capacitor is connected to the common electrode.

10. The liquid crystal display panel according to claim 7, wherein the liquid crystal display panel further comprises a figure display area, the figure display area includes a pixel area formed by alternately arranging a plurality of the data lines and a plurality of the scan lines, and each of the pixel units is disposed in the pixel area.

11. The liquid crystal display panel according to claim 10, wherein the liquid crystal display panel further comprises a source driver and a gate driver, the source driver is coupled with the data lines for providing the data signals to the figure display area, and the gate driver is coupled with the scan lines for providing the scan signals to the figure display area.
